(19) United States
(12) Patent Application Publication
(10) Pub. No.: US 2026/0348804 A1
(43) Pub. Date: Nov. 5, 2026

(54) CONTROLLING SAMPLE ENVIRONMENT IN THERMAL ANALYSIS INSTRUMENTS

(71) Applicant: TA Instruments-Waters LLC, New Castle, DE (US)

(72) Inventors: Reginald Lee, West Chester, PA (US); Xiaoping Hu, New Castle, DE (US); Anthony Joseph Defazio, HISTORIC NEW CASTLE, DE (US); Arthur Ortner, New Castle, DE (US); Christopher Ubelacker, West Chester, PA (US); Scott Merrullo, Newark, DE (US); Rohan Shende, Newark, DE (US)

(21) Appl. No.: 19/664,229

(22) Filed: Apr. 30, 2026

Related U.S. Application Data
(60) Provisional application No. 63/797,552, filed on Apr. 30, 2025.

(51) Int. Cl. G01N 1/44; G01N 1/42

(52) U.S. Cl. CPC G01N 1/44; G01N 1/42

(57) ABSTRACT

An apparatus for controlling an environment in which a sample is positioned for thermal analysis comprises an actuated tray cover constructed and arranged for positioning over a top surface of a sample tray to form a chamber providing a controlled environment between the tray cover and the sample tray; a purge gas control system that distributes a purge gas to the chamber; and a temperature-controlled tray holder coupled to a bottom surface of the sample tray to provide temperature control and thermal isolation to the chamber.

### CROSS-REFERENCE TO RELATED APPLICATIONS

This application claims priority to U.S. Application No. 63/797,552, titled CONTROLLING SAMPLE ENVIRONMENT IN THERMAL ANALYSIS INSTRUMENTS, filed Apr. 30, 2025, which is hereby incorporated by reference in its entirety.

### FIELD OF THE PRESENT DISCLOSURE

The disclosed technology generally relates to thermal analysis instruments. More particularly, the disclosed technology relates to a temperature and environmental control chamber for samples pending thermal analysis

### BACKGROUND

Thermal analysis instruments such as Differential Scanning Calorimetry (DSC), Thermogravimetric Analysis (TGA), and Simultaneous Differential Thermal (SDT) Analysis systems often utilize a multi-sample tray to store multiple prepared pairs of samples and reference materials for testing, for example, measuring the differential heat flow between a given sample cell and its corresponding reference cell. For workflow efficiency, a large number of samples are typically prepared and loaded into a thermal analysis instrument over the course of several hours, after which each sample undergoes predetermined testing. Each test can range from minutes to hours depending on the test parameters. With trays supporting dozens of samples, this may take hours or days between sample preparation and testing. During this time, the samples of interest are exposed to the ambient environment which may cause unintended or undesirable changes to the sample. For example, dust may fall onto the sample, the sample may react with oxygen or evaporate, or may increase or decrease to an undesirable temperature.

### SUMMARY

In some aspects, an apparatus for controlling an environment in which a sample is positioned for thermal analysis comprises an actuated tray cover constructed and arranged for positioning over a top surface of a sample tray to form a chamber providing a controlled environment between the tray cover and the sample tray; a purge gas control system that distributes a purge gas to the chamber; and a temperature-controlled tray holder coupled to a bottom surface of the sample tray to provide temperature control and thermal isolation to the chamber.

### BRIEF DESCRIPTION OF THE DRAWINGS

Advantages of this present disclosure may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles with reference to the concepts described in the present disclosure.

FIG. 1A is a perspective view of a thermal instrument having a liquid-cooled sample station in a closed state, in accordance with some embodiments.

FIG. 1B is a perspective view of the liquid thermal instrument of FIG. 1A having the liquid-cooled sample station in an open state, in accordance with some embodiments.

FIG. 2 is an exploded view of an automated tray cover system, in accordance with some embodiments.

FIG. 3 is a perspective view of a temperature-controlled tray holder, in accordance with some embodiments.

FIG. 4 is a perspective view of a temperature control system and purge gas control system for controlling an interior environment of the tray holder of FIG. 3, in accordance with some embodiments.

FIG. 5 is another perspective view of a temperature control system and purge gas control system for controlling an interior environment of the tray holder of FIG. 3, in accordance with some embodiments.

FIG. 6 is a front view of the temperature control system and purge gas control system of FIG. 5.

FIG. 7 is a side view of the temperature control system and purge gas control system of FIGS. 5 and 6 controlling the temperature-controlled tray holder of FIG. 3, in accordance with some embodiments.

FIG. 8 is a rear view of the temperature control system and purge gas control system of FIG. 5.

FIG. 9 is another perspective view of the purge gas control system, in accordance with some embodiments.

FIGS. 10-12 are system control flow diagrams, in accordance with some embodiments.

FIG. 13A is a perspective view of a thermal instrument having an air cooled sample station in a closed state, in accordance with some embodiments.

FIG. 13B is a perspective view of the thermal instrument of FIG. 13A having the air cooled sample station in an open state, in accordance with some embodiments.

FIG. 14 is a perspective view of a housing of the thermal instrument of FIGS. 13A and 13B, in accordance with some embodiments.

FIG. 15 is an exploded perspective view of an air-cooled temperature control system and purge gas control system of the thermal instrument of FIGS. 13A-14, in accordance with some embodiments.

FIG. 16 is a front view of the air-cooled temperature control system and purge gas control system of the thermal instrument of FIGS. 13A-15, in accordance with some embodiments.

FIG. 17 is an exploded perspective view of the thermal instrument with air-cooled sample station of FIGS. 13A-16, in accordance with some embodiments.

FIGS. 18 and 19 are other system control flow diagrams, in accordance with some embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

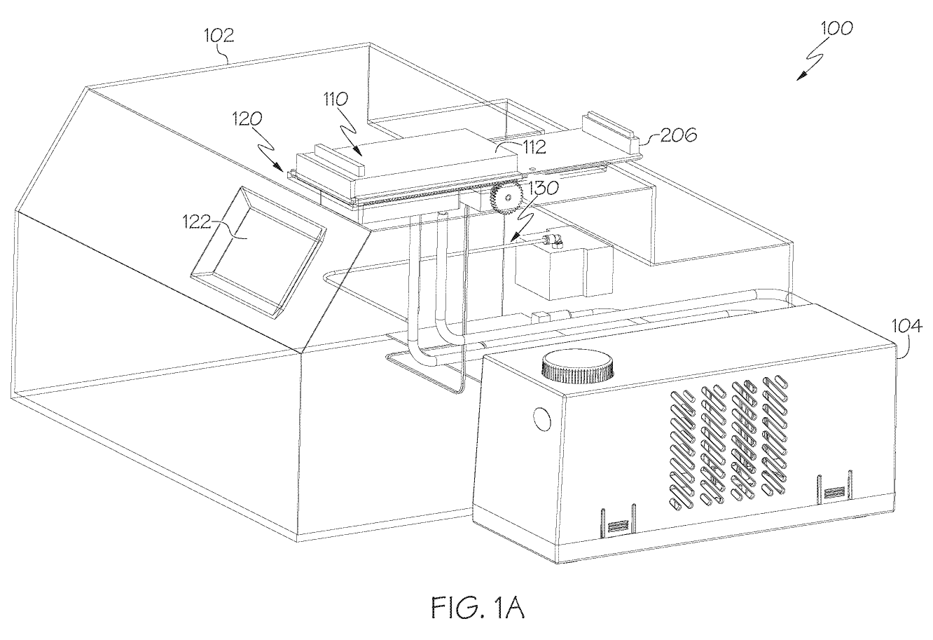

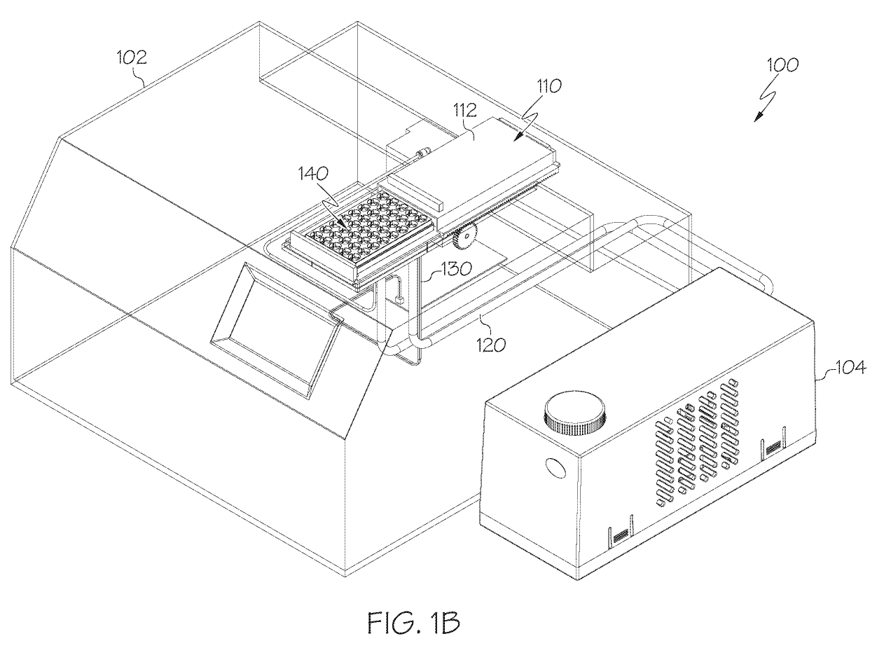

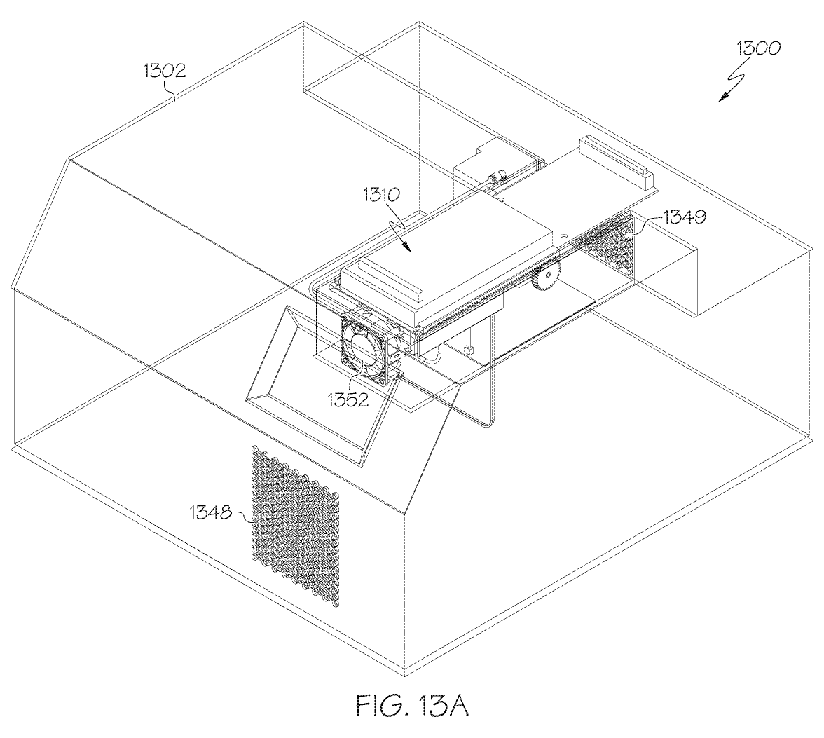

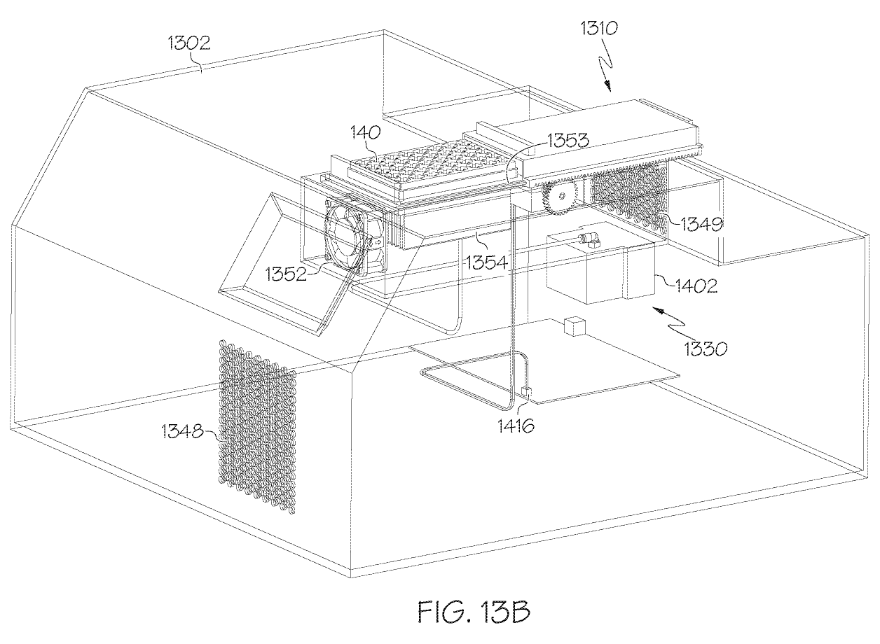

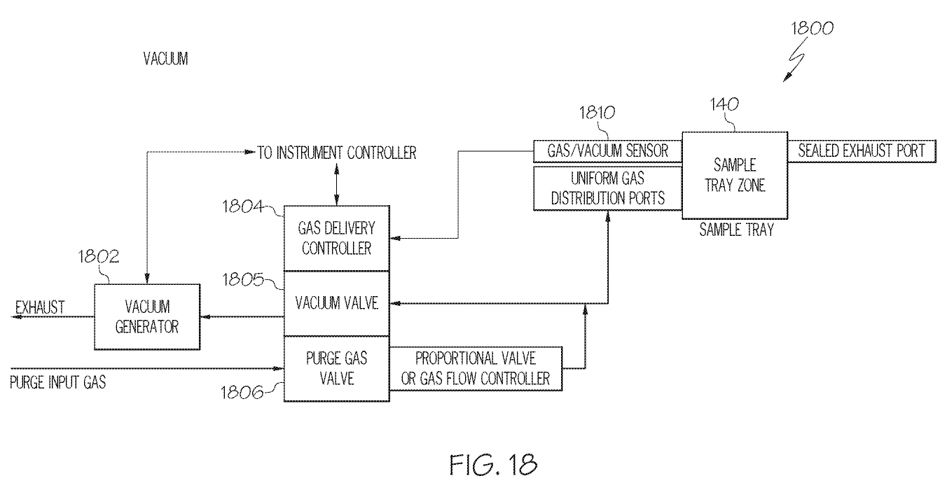

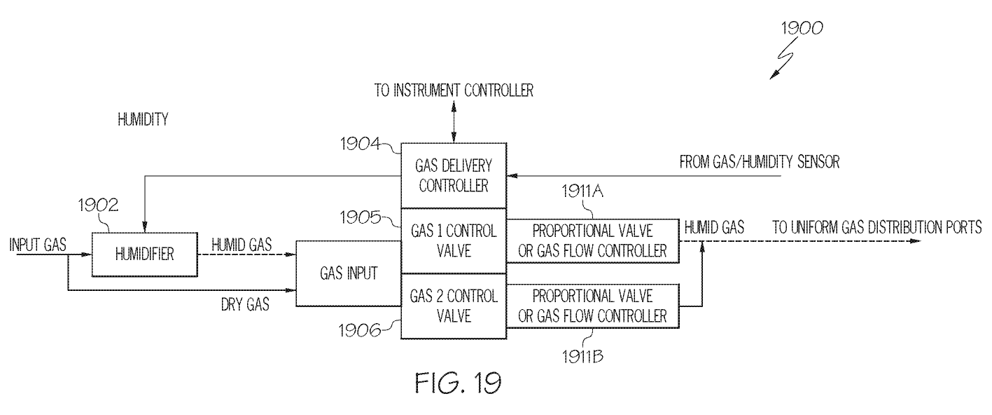

In brief overview, embodiments of the present inventive concept include an apparatus for controlling an environment in which a sample is positioned for thermal analysis, comprising: an actuated tray cover constructed and arranged for positioning over a top surface of a sample tray to form a chamber providing a controlled environment between the tray cover and the sample tray; a gas flow control module that distributes a purge gas to the chamber; and a temperature-controlled tray holder coupled to a bottom surface of the sample tray to provide temperature control and thermal isolation to the chamber. These four components, namely, the removable sample tray containing samples for testing, temperature controlled tray holder, gas control module for supplying purge gas as need, and automated or manually controlled retracting and sealing cover collectively allow for temperature control, purge gas control, and environmental isolation for the samples prior to and after testing in a sample cell used in a thermal analysis instrument. In some embodiments, the apparatus includes a controller that manages these four components to maintain desirable sample conditions and temperature and environmental control during long workflows. The temperature control can be achieved using heaters, Peltier units, an external chiller and heat exchanger, chilled or heated fluids, gas expansion chillers, and/or other systems or devices that provide heat generation or removal. In some embodiments, a Peltier element is air cooled, i.e., using a heatsink and fan for example shown in FIG. 13. In other embodiments, the Peltier element is liquid cooled, i.e., using pure water and an external chiller for example shown in FIG. 1A. Regardless of whether the instrument is liquid-cooled or air-cooled, temperature control can be achieved. In other embodiments, an external PID thermal controller is used. In other embodiments, temperature control may be performed for various purposes such as maintaining a body temperature for pharmaceutical materials, maintaining refrigeration or freezer conditions, suppressing reactions, and so on. Purge control may be performed using active gas purge using a gas delivery module or mass flow controller of various reactive or inert gasses. Vacuum may be used to further control the atmosphere of the sample of interest (see FIG. 18). Similarly, a different pre-treatment may be used to control humidity. Relative humidity or other chemical species may be introduced to produce the desired environment for the sample in the chamber formed by the cover and tray holder (see FIG. 19). These gasses may also be pre-heated or otherwise pretreated prior to entering the sample space.

FIG. 1A is a perspective view of a thermal instrument with liquid heat exchanger 100 having the sample station 110 in a closed state, in accordance with some embodiments. FIG. 1B is a perspective view of the thermal instrument with a liquid heat exchanger 100 of FIG. 1A having the sample station 110 in an open state, in accordance with some embodiments. In some embodiments, the thermal instrument 100 may be a Differential Scanning Calorimetry (DSC) system. In other embodiments, the sample station 110 is constructed for a Thermogravimetric Analysis (TGA) or Simultaneous Differential Thermal (SDT) Analysis system. The sample station 110 may be part of an autosampler of the thermal instrument 100, which is used to automate the running of multiple samples, for example, a sample tray 140 queuing up to 54 samples, or more for automated testing by the thermal instrument 100. The autosampler, or more specifically, the sample station 110, is constructed and arranged to provide an environmental control chamber for samples alone or in combination with reference materials for thermal analysis testing. In some embodiments, the chamber may be seal-tight, for example, when the apparatus includes vacuum-related components. The autosampler permits the samples to undergo automated testing ranging from hours to several days. Such environmental control may include the control of temperature, purge, humidity, atmosphere, contamination, and so on, while queued in the sample holder for subsequent testing and analysis.

The sample tray 140 may be formed of aluminum or other non-insulative heat conducting material, and comprise an array of wells to accommodate a plurality of samples in vials or the like positioned in the wells, which can be automatically introduced into the thermal instrument 100 for analysis. The tray 140, or tray body, can be coupled to a plate, for example, formed of aluminum or stainless steel, which can serve as a thermal conducting plate.

In some embodiments, the sample station 110 includes an automated cover system 112, a temperature-controlled tray holder 120, and a purge gas control system 130, which create a controlled environment surrounding a sample tray 140. In some embodiments, the sample tray 140 is an autosampler tray. The thermal instrument 100 may include a housing 102 positioned about the purge gas control system 120 and a temperature control system that control the sample tray environment.

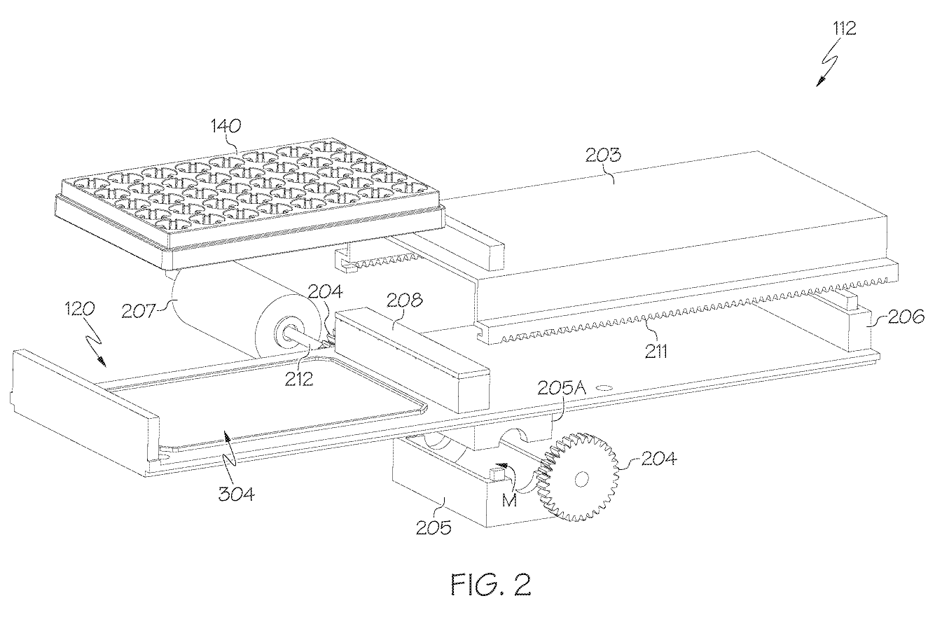

FIG. 2 is an exploded view of an automated tray cover system 112 of the sample station 110 of FIGS. 1A and 1B, in accordance with some embodiments.

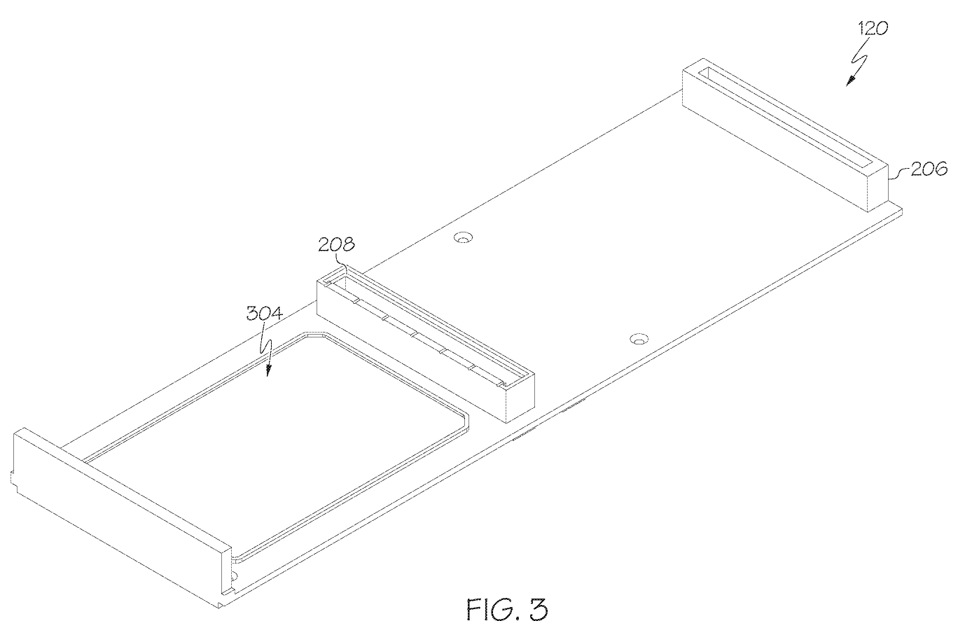

As shown, the tray holder 120 may be part of the automated tray cover system 112. The tray holder 120 may be formed of various materials, including but not limited to aluminum, steel, or other structural material. In some embodiments, the tray holder 120 is heat conducting, and includes an insulative separator. The cover system 112 has a sliding tray cover 203, which when positioned on the tray holder 120 forms an environment-controlled chamber in which the sample tray 140 is positioned. For example, manual or automatic retracting and closing of the chamber 304 by the cover 203 may be performed to maintain the environment in the chamber 304 with respect to an applied vacuum, humidity level, and the like in response to an applied source of active, inert, or other relevant gasses. The chamber region 304 shown in FIG. 3 may be conductive and contact the conductive surface of the tray 140.

The tray cover 203 may provide for environmental isolation with maintained visibility. The tray cover 203 may be translucent, e.g., formed of clear polycarbonate or the like, but not limited thereto. The tray cover 203 has a bottom region 211 that is positioned about the tray holder 120 and constructed and arranged to engage with the gear(s) 204 to move laterally relative to the tray holder 120. The motor 207 provides a rack and pinion drive using the gears 204 and bottom region 211 of the cover 203. In doing so, the cover 203 opens to expose the sample tray 140 (see FIG. 1B) and closes to cover the sample tray 140 (see FIG. 1B). Other embodiments may include alternatives to a rack and pinion drive, for example, a magnetic drive system, etc.

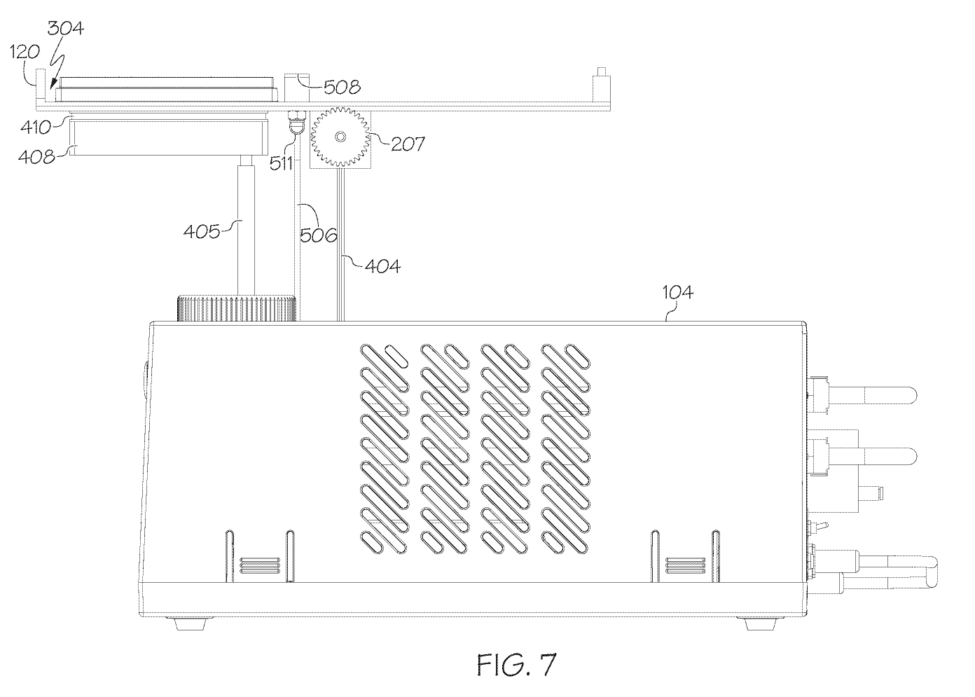

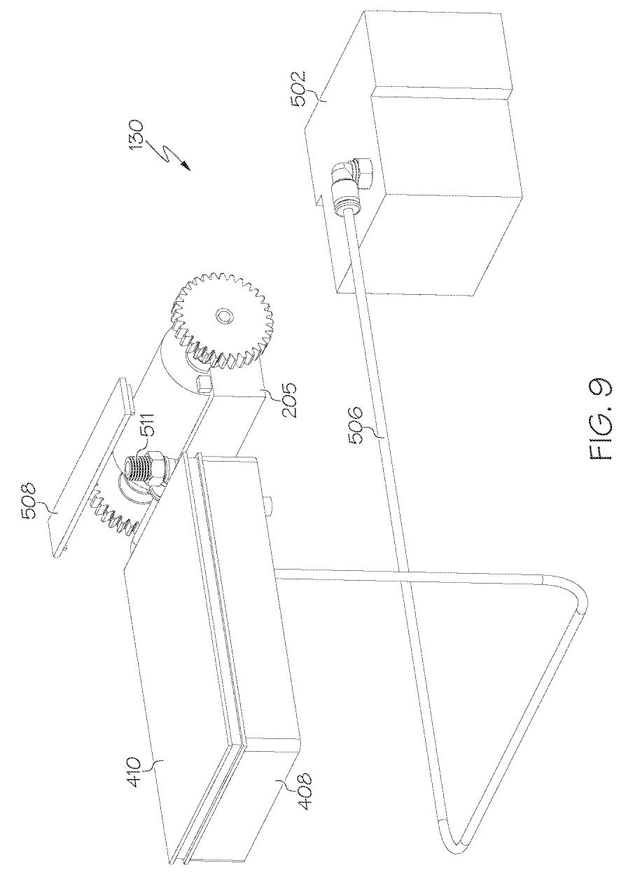

In some embodiments, the automated cover system 112 includes at least one gear 204, a motor clamp 205, a back stopper 206 for the cover 203, a motor 207, and a gas distribution chamber 208. At least one gear 204 may be formed of plastic but not limited thereto. In some embodiments, the motor shaft 212 has a dual shaft. The motor clamp 205 couples to, e.g., mates with a top portion 205A that is attached to or integral with, i.e., a single piece, the bottom surface of the tray holder 120 for receiving and positioning the motor 207, which when assembled is positioned between the two gears 204, e.g., at location M shown in FIG. 2. The back stopper 206 can likewise be attached to or integral with an opposite end of the tray holder 120 as the region of the chamber 304 in which the tray 140 is inserted. As shown in FIG. 1A, the back stopper 206 prevents the cover 203 for sliding laterally beyond the end of the tray holder 120. The gas distribution chamber 208 is coupled to an end of a purge gas line 506 of a purge gas control system 130 (see FIGS. 7 and 9), and provides a plurality of outlets for distributing a source of purge gas to the chamber where the sample tray 140 is positioned. Although not shown, the cover system 112 can include one or more motor stall and position sensors for safety, manual override, and position control.

Accordingly, the actuated tray cover system 112 can be opened or closed automatically through any form of mechanical or electronic actuation. For example, as shown, the tray cover 203 can be triggered by the motor 203, or may be triggered by a hydraulic or pneumatic mechanism. The flow rate of gas to the chamber housing the sample tray 140 and/or temperature of the chamber may be controlled according to the movement of the actuated tray cover. For example, when the cover 112 is in a closed position, i.e., positioned over the top of the chamber, the temperature control may be applied to cool the interior temperature. Another example is that in anticipation or when the cover is open or when gas flow is modified, heating/cooling control is adjusted to maintain the desired temperature due to the changing gas flow and cover condition. Similarly, the purge gas control system 130 may change the flow rate of purge gas based on the cover 112 in the closed state. For example, a high flow rate may be applied when the cover 112 is open and a lower flow rate may be applied when the cover 112 is closed.

The tray holder 120 is constructed and arranged to couple with the tray cover 203 to form an enclosure, or chamber 304 providing a controlled environment between the tray cover 203 and the sample tray 140. In particular, the tray holder 120 may provide temperature control to the sample tray 140 in the chamber 304.

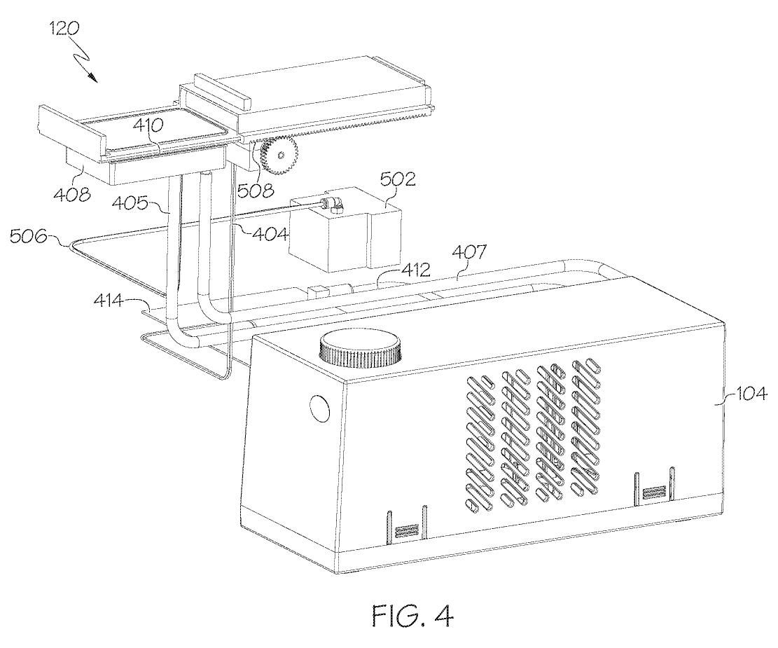

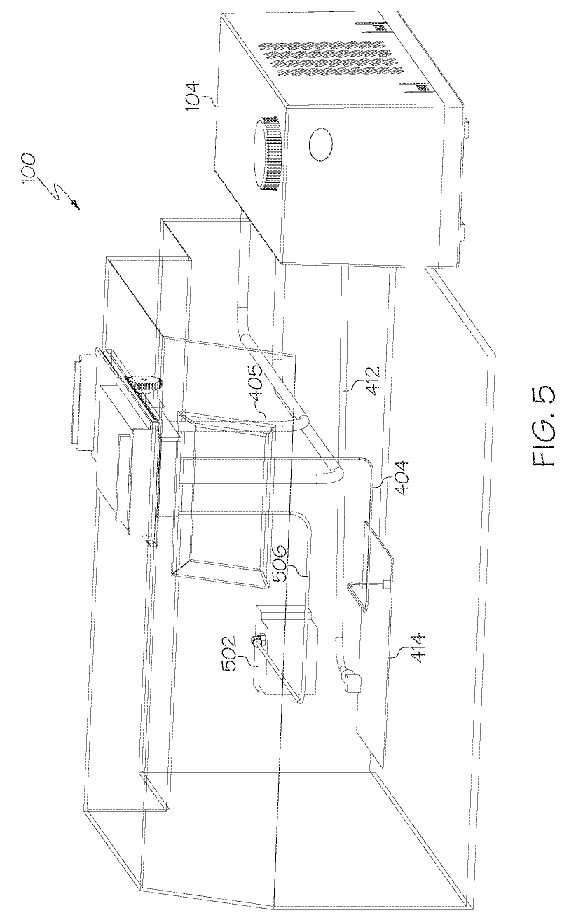

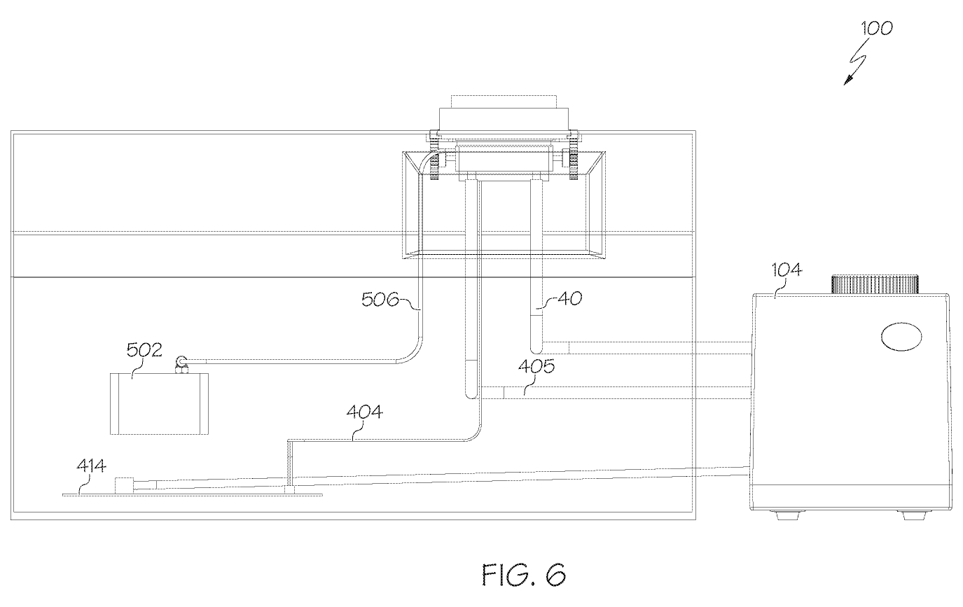

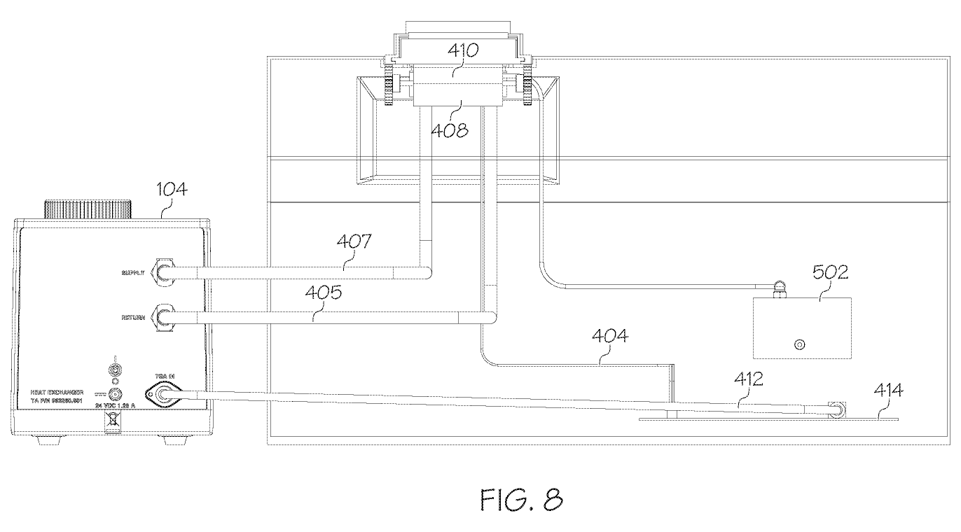

As shown in FIGS. 3-8, the tray holder 120 provides temperature control and thermal isolation to the chamber 304 by receiving inputs from a temperature control system and purge gas control system 130, respectively.

The thermal instrument 100 with liquid-cooled sample station includes a temperature control system and purge gas control system 130 for controlling an interior environment of the tray holder 120 of FIG. 3, in accordance with some embodiments. The sample station 110, temperature control system and purge gas control system 130 operate together to provide an environmental isolation chamber for the sample tray 140, a gas environment about the samples in the tray 140, and temperature control and monitoring of the tray 140.

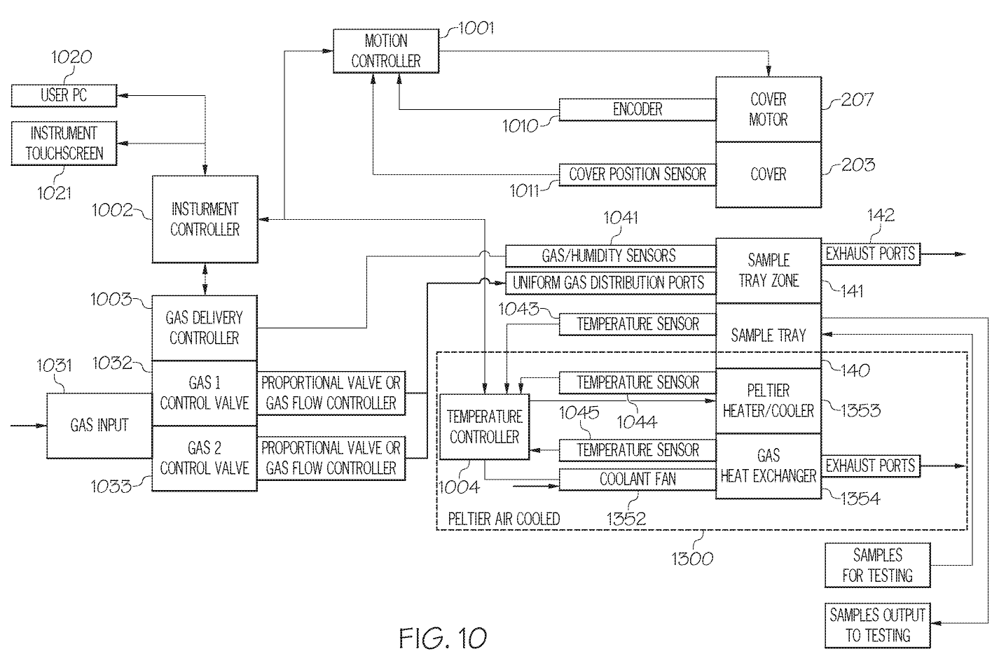

The temperature control system may comprise a heat exchanger 104, a return line or tube 405, a supply line or tube 407, a cooling plate 408, a Peltier plate 410, an event cable 412, and a control board 414. The temperature control system may provide temperature control using this combination of heaters, Peltier units, external chiller and heat exchanger, chilled or heated fluids, or gas expansion chillers or other means of heat generation or removal. The heat exchanger 140 may include a liquid reservoir that supplies the tray holder 120 with coolant to dissipate heat from the tray holder 120. The coolant exits the heat exchanger 140 through the supply line 407, circulates to the cooling plate 408 under the tray holder 120, and returns to the heat exchanger 104 via the return line 405. The cooling plate 408 and Peltier plate 410 form a heating/cooling assembly that provides uniform heating and cooling of the chamber 304 in which the sample tray 140 is positioned. The control board 414 provides temperature control to the heat exchanger 104 via the event cable 412, described in greater detail with respect to FIGS. 10-12. In some embodiments, the control board 414 has an electrical interface for coupling motor leads 404 that extend from the control board 414 to the motor 207. The motor leads 404 include electrical wires or connections that transmit power and control signals from the control board 414 to the motor 207 allow the control board 414 to control the motor's speed, direction, and operation in connection with temperature control and purge gas operations. In some embodiments, the control board 414 has a computer interface, such as a wired or wireless connectors to communicate with the touchscreen 122 and or external user computer (not shown), e.g., a user interface remote from the apparatus. For example, the user computer can have a user interface to send and receive information for controlling the operation of the instrument 100 via the control board 414.

The purge gas control system 130 comprises a gas delivery module 502, a sample tray purge gas line 506, a gas distribution chamber 508, and a tube fitting 511 for outputting a source of purge gas from the gas delivery module 502 to the sample tray 140 inside the chamber 304 in the tray holder 120. The gas delivery module 502 can provide a single gas or combine multiple gases as a main sample purge. Gasses may include but are not limited to nitrogen, helium, argon, oxygen, air, carbon dioxide, or a combination thereof. In some embodiments, a dry purge is provided to prevent condensation or provide preconditioning, i.e., drying, of the samples in the tray 140. For example, while cooling a Peltier element, the construction of the apparatus may allow connections to a chiller or the like, but also vent holes for condensation prevention, etc. In other embodiments, an air-cooled apparatus, e.g., shown in FIG. 13A, does not have an external chiller but may still have vent holes.

Other purge gases may be provided by the gas delivery module 502 for heating, cooling, or humidifying, the sample tray 140 for preconditioning the samples. In other embodiments, cooling of the tray 140 or tray holder 120 can be performed using vortex tube cooling where compressed air expansion is performed. Here, the compressed air can be alternatively used as a purge gas. For example, the compressed air chiller may include a vortex tube or the like that can generate cold compressed air which would then be circulated under a heat exchanger plate, e.g., proximal cooling plate 408 and Peltier plate 410, to cool the samples (thereby cooling via conduction). In other embodiments, the cold compressed air generated by the vortex tube is directly pushed into the enclosed chamber thereby using the cold gas to keep the sample cold (thereby cooling via convection). Additionally, an external gas line can be included for compressed air to generate the heat exchange and purge out of the vent holes.

FIGS. 10-12 are system control flow diagrams, in accordance with some embodiments. In describing the flow diagrams, reference is made to the thermal instrument 100 with liquid-cooled sample station.

The thermal instrument 100 with liquid-cooled sample station may include a plurality of controllers, namely, a motion controller 1001, an instrument controller 1002, a gas delivery controller 1003, and a temperature controller 1004. Some or all of these controllers 1001-1004 may be part of the control board 414. In other embodiments, some or all of these controllers 1001-1004 are external to the thermal instrument 100 with liquid-cooled sample station and in communication with the relevant components of the thermal instrument 100 shown and described.

The motion controller 1001 has a first input for receiving data from the instrument controller 1002 and/or temperature controller 1004 regarding the control of movement of the tray cover 203 via an output to the motor 207. Accordingly, in some embodiments, the motion controller 1001 can be part of the automated tray cover system 112 shown in FIG. 2. The motor 207 may have an encoder 1010 that provides a second input to the motion controller 1001 to determine the movement of the tray cover 203 relative to the tray holder 120. The cover 203 may have a position sensor 1011 that provides a third input to also determine the movement of the tray cover 203 relative to the tray holder 120. Accordingly, the motion controller 1001 processes the first through third inputs to control the motor 207 and therefore the movement of the cover 203.

As described above, the instrument controller 1002 provides the first input to the motion controller 1001. The instrument controller 1002 may receive some inputs from a remote computer 1020 and/or a touchscreen 122 positioned in the thermal instrument housing 102 (see FIG. 1A). Such inputs may include instructions for establishing the environmental conditions of the sample tray 140, for example, instructions to the temperature controller 1004 to establish a temperature inside the chamber 304 in which the tray 140 is inserted and/or instructions to the motion controller 1001 to position the cover 203 over the tray 140, and so on.

The instrument controller 1002 may receive other inputs from the purge control system 130, which in some embodiments also includes a gas input 1031, e.g., from the gas delivery module 502 and gas source, gas control valve(s) 1032, 1033, and the gas delivery controller 1003, which can provide data regarding purge gas controls to the instrument controller 1002 in response to various states of the control valve(s) 1032, 1033. A first proportional valve or gas flow controller 1034 may communicate with the first gas control valve 1032, for example, via a pneumatic line between the gas flow controller 1034 and the sample tray and chamber. A second proportional valve or gas flow controller 1035 may communicate with the second gas control valve 1033. The first and second proportional valves/ gas flow controllers 1034, 1035 may control an output of purge gas through uniform gas distribution ports of the gas distribution chamber 508 (see FIG. 7).

During operation, purge control can be performed using an active gas purge including the purge control system 130, or more specifically, a combination of the gas delivery controller 1002, proportional valves or gas flow controllers 1034, 1035, and gas control valves 1032, 1033 that process various reactive or inert gasses.

Gas flow control may provided by the gas delivery controller block (1003, 1032, 1033, 1034, 1035). The valves (1032 and 1033) can be manual or controlled by the gas delivery controller 1003, e.g., including a solenoid or the like. The proportional valves 1034, 1035) may be manual or constant, for example, manual pressure control with an orifice for a constant gas flow rate or a restrictor) or it can be controllable through a proportional valve with control signal from the gas delivery controller 1003.

In some embodiments, the gas delivery controller 1003 receives electronic inputs from one or more gas and/or humidity sensors 1041 which are positioned about at least one sample tray zone 141 of the sample tray 140 or sample station 110. The sensors 1041 collect data regarding the environment at the tray 140 and provides it to the gas delivery module 1003 to control the gas control components 1031-1035 to output a corresponding source of gas to the uniform gas distribution ports 1042, e.g., at the gas distribution chamber 508, which in turn provide the gas to the sample tray zone 141 of the tray 140 where the sensor 1041 is located. In some embodiments, the sample tray 140 includes one or more exhaust ports 142 for the escape of gas, humidity, heat, etc. so that the chamber 304 can be controlled accordingly.

FIGS. 18 and 19 are other system control flow diagrams, in accordance with some embodiments. In particular, FIG. 18 illustrates a thermal instrument 1800 including a vacuum generator 1802, gas delivery controller 1804, vacuum valve 1805, purge gas valve 1806, and gas/vacuum sensor 1810 at a sample tray 140. An instrument controller is connected to the vacuum generator 1802 and gas delivery controller 1804. The blue arrows illustrate a vacuum flow path generated by the instrument 1800. FIG. 19 illustrates a thermal instrument 1900 including a humidifier 1902, gas delivery controller 1904, and gas control valves 1905, 1906, each having a proportional valve or gas flow controller 1911A, B, respectively. The blue arrows illustrate a gas flow and the red arrows illustrate a humid gas flow.

FIG. 13A is a perspective view of a thermal instrument 1300 having an air-cooled sample station 1310 in a closed state, in accordance with some embodiments. FIG. 13B is a perspective view of the thermal instrument 1300 of FIG. 13A having the air-cooled sample station 1310 in an open state, in accordance with some embodiments.

In addition to the air-cooled sample station 1310, the thermal instrument 1300 includes a purge gas control system 1330 and a temperature control system 1340 which interfaces with the air-cooled sample station. The thermal instrument 1300 includes components such as the air-cooled sample station 1310 that are similar to those of the thermal instrument 100 with liquid-cooled sample station described above so details thereof are not repeated for brevity. However, the housing 1302, purge gas control system 1330, and temperature control system 1340 have differences, described as follows.

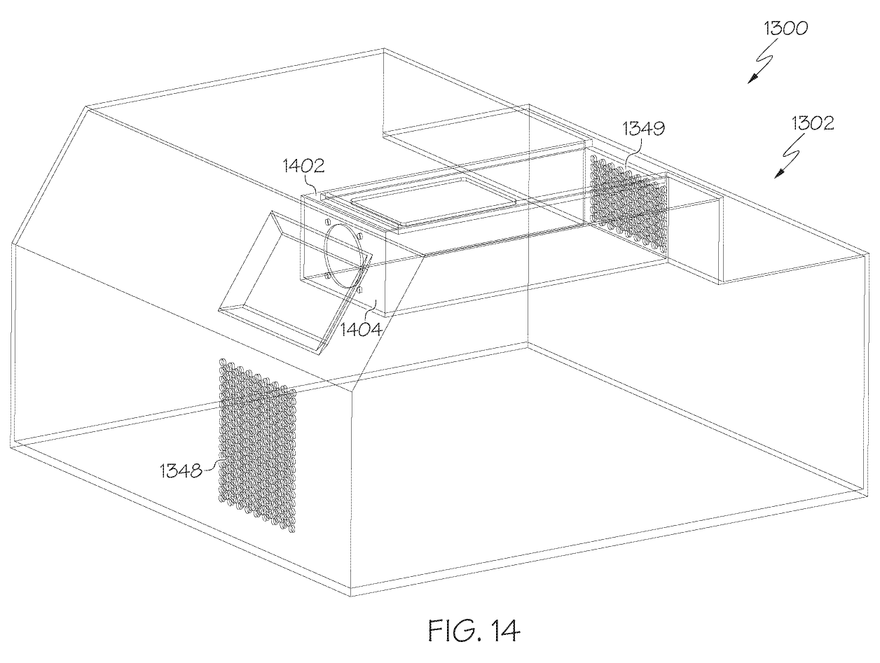

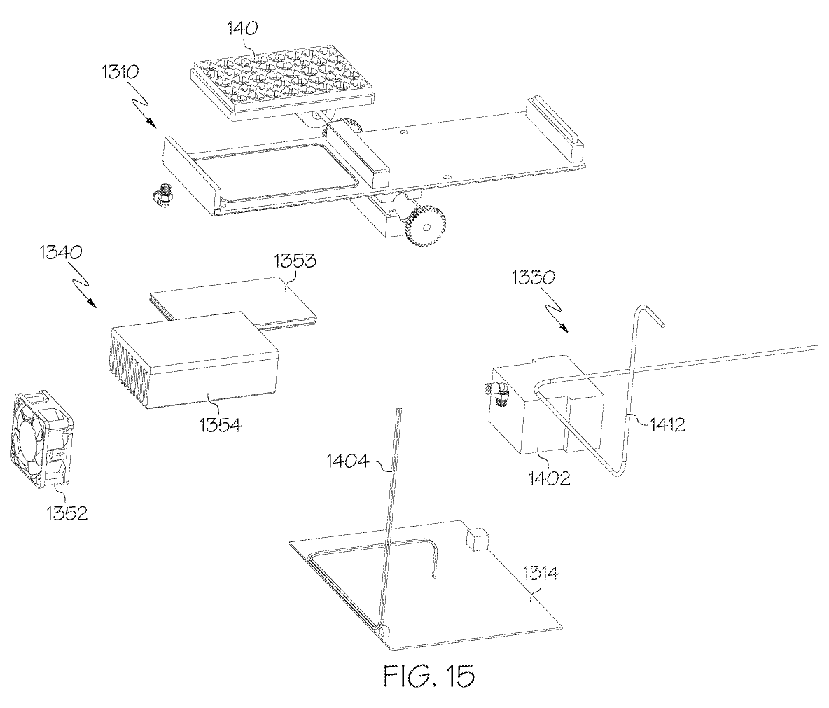

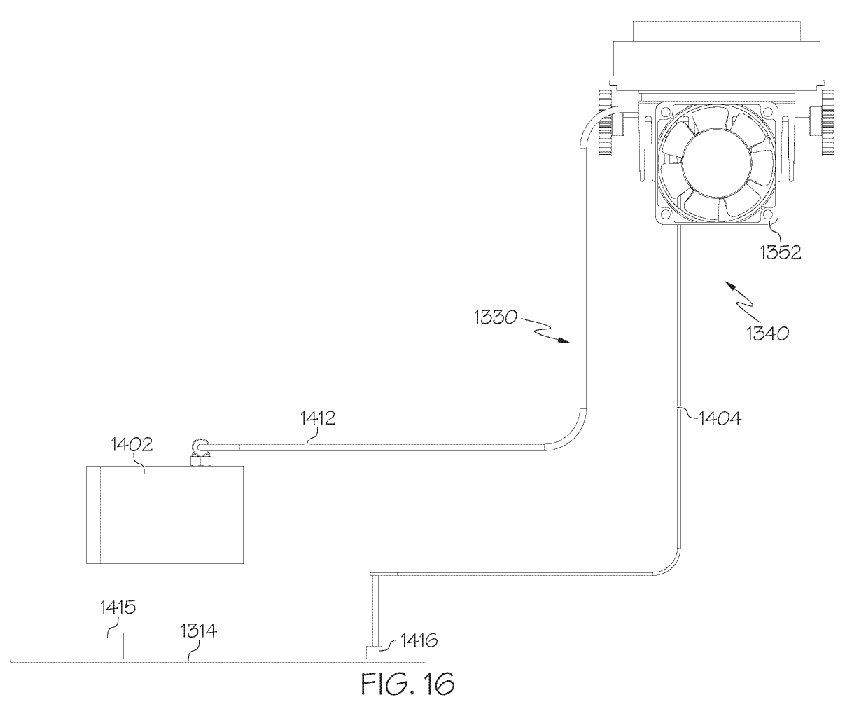

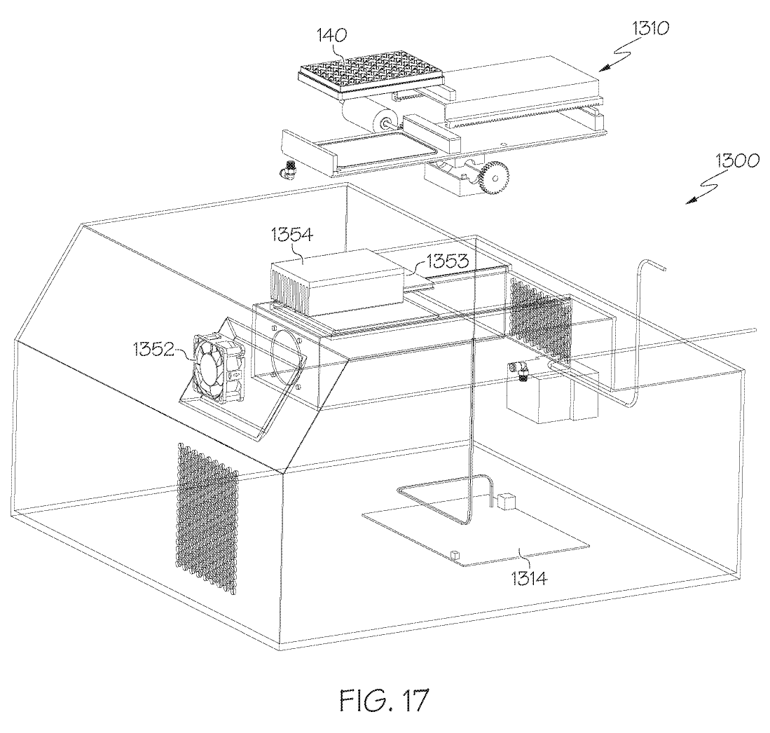

As shown in FIG. 14, the air-cooled housing 1302 is not constructed to communicate with an external heat exchanger, and instead, includes a gas delivery module 1402 having an end 1404 configured to receive and couple to a fan 1352, and an interior that houses a Peltier element 1353 and heat sink 1354 separated from the fan 1352 by a predetermined distance. The fan 1352 provides temperature control inside the sub-housing 1402, for example, by cooling the components during operation. The housing 1302 also includes a first vent 1348 at a front side of the housing 1302 and a second vent 1349 at a rear end to form an air flow path through the sub-housing 1402. This circulating air in combination with the heat sink 1354 can provide temperature control for the Peltier element 1353.

The purge gas control system 1330 of the thermal instrument 1300 with air-cooled sample station may be similar to the purge gas control system of the thermal instrument 100 with liquid-cooled sample station of FIGS. 1-9, namely, a sample tray purge gas line 1412, gas delivery module 1402, etc., so details are not repeated for brevity.

The control board 1314 of the thermal instrument 1300 with air-cooled sample station may be similar to the control board 414 of the thermal instrument 100 with liquid-cooled sample station of FIGS. 1-9, in that the control board 1314 has an interface 1416 for coupling motor leads 404 that extend from the control board 1314 to the motor. Other interfaces may include an autosampler interface.

The temperature control system 1340 of the thermal instrument 1300 with air-cooled sample station may be similar to the temperature control system of the thermal instrument 100 with liquid-cooled sample station of FIGS. 1-9, except for the absence of a chiller, heat exchanger, and the like. Instead, the temperature control system 1340 includes the fan 1352, heat sink 1354, and vents 1348, 1349 for temperature control, for example, cooling the Peltier element 1353.

Referring again to the system control flow diagram 1000 of FIG. 10, the air-cooled thermal instrument 1300 may further comprise the temperature controller 1004 and temperature sensors 1044,1045. The temperature controller 1004 has inputs for connected to the instrument controller 1002, temperature sensors 1044, 1045, and gas delivery controller 1003. Temperature sensor 1044 can monitor the temperature of the Peltier element 1353, i.e., heater or cooler. Temperature sensor 1045 can monitor the temperature of the heat sink 1354, or related gas heat exchanger. The temperature controller 1004 can process one or more of these inputs and control the cooling fan 1352 and/or Peltier element 1353 accordingly, which in turn control the temperature of the sample tray 140.

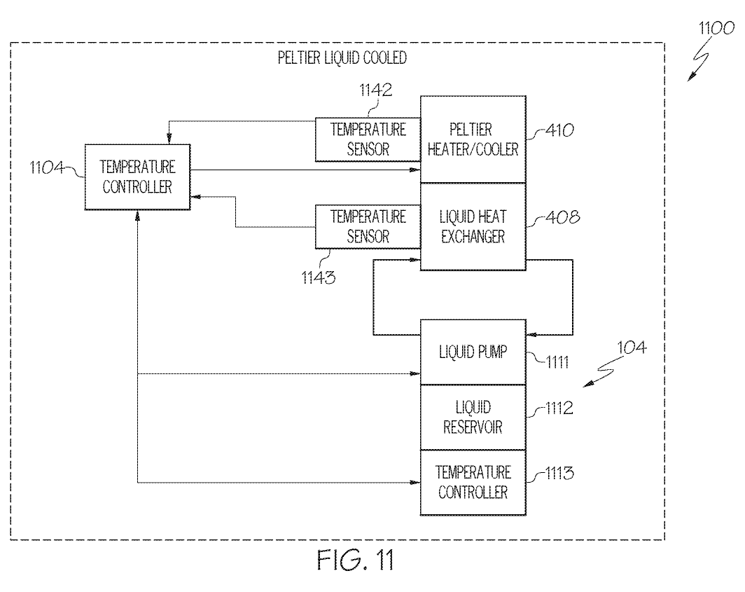

FIG. 11 is a block diagram of the thermal instrument 100 with liquid-cooled sample station that can be part of the system control flow diagram 1000, and can replace the air-cooled thermal instrument 1300 shown in FIG. 10. As shown, in some embodiments, the thermal instrument 100 with liquid-cooled sample station includes a temperature controller 1004, a temperature sensor 1142, 1143, and Peltier element 410, similar to those shown in FIG. 10. In addition, the heat exchanger 408 has an input and output, respectively, for exchanging fluid for temperature control with the external heat exchanger 104, which may include a pump 1111, liquid reservoir 1112, and temperature controller 1113. The temperature controller 1104 can exchange control data with the pump 1111 and temperature controller 1113 of the heat exchanger 104.

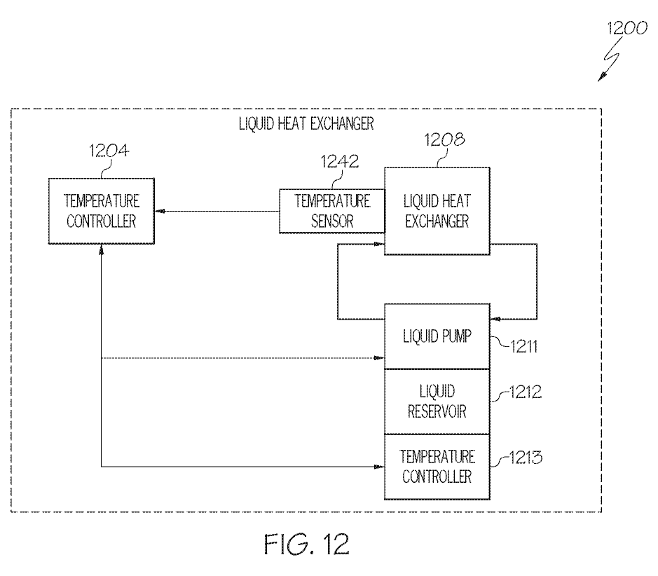

FIG. 12 is a block diagram of a liquid heat exchanger 1200 that can be part of the system control flow diagram 1000, and can replace the air-cooled thermal instrument 1300 shown in FIG. 10. As shown, in some embodiments, the liquid heat exchanger 1200 is similar to the flow diagram 1100 of FIG. 11, except for the absence of a Peltier element. However, the heat exchanger 1200 includes a first temperature controller 1204, single temperature sensor 1242, pump 1211, liquid reservoir 1212, and second temperature controller 1213.

As disclosed herein, embodiments of the present inventive concept include an apparatus for controlling an environment in which a sample is positioned for thermal analysis. In some embodiments, the apparatus is a Differential Scanning Calorimetry (DSC) automation system that can boost throughput need a dependable solution to preserve the integrity of sensitive samples while they are queued for thermal testing. This ensures the accuracy of the data, which is critical for reliable analysis and decision making. Applications may include but not be limited to biological and pharmaceutical sample analysis, for example, where specific temperature requirements must be adhered to, e.g., USP Protocol states 2-8 ºC for drug storage; Serum/Plasma storage = 4 ºC. Other applications may include polymerization control and sample preconditioning for general samples (drying). Other applications may relate to decomposition analysis, cryogenic, and body temperature.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An apparatus for controlling an environment in which a sample is positioned for thermal analysis, comprising:
an actuated tray cover constructed and arranged for positioning over a top surface of a sample tray to form a chamber providing a controlled environment between the tray cover and the sample tray;
a purge gas control system that distributes a purge gas to the chamber; and
a temperature-controlled tray holder coupled to a bottom surface of the sample tray to provide temperature control and thermal isolation to the chamber.

2. The apparatus of claim 1, wherein the actuated tray cover is constructed and arranged over the sample tray having a plurality of compartments, each holding a different sample, and wherein the gas flow control module distributes the purge gas uniformly to each of the plurality of compartments.

3. The apparatus of claim 1, wherein the controlled environment includes a plurality of environmental conditions, including a combination of atmosphere, temperature, humidity, and contamination.

4. The apparatus of claim 1, wherein the actuated tray cover comprises:
a translucent cover for providing environmental isolation with maintained visibility for the chamber;
a motor including a rack and pinion drive; and
a motor stall and position sensors for safety, manual override, and position control.

5. The apparatus of claim 1, wherein the temperature-controlled tray holder comprises:
a tray mount;
at least one Peltier element that provides a controlled source of heat to the tray mount; and
a heat sink.

6. The apparatus of claim 5, wherein at least one of the Peltier element and the chamber is air cooled, and includes a plurality of fans and vents for the air cooling.

7. The apparatus of claim 5, wherein at least one of the Peltier element and the chamber is liquid cooled.

8. The apparatus of claim 1, wherein the temperature-controlled tray holder comprises:
a plate thermally conductive to the tray and thermally insulated from the other components of the apparatus; and
a chill plate for controlling the temperature of the thermal insulating plate.

9. The apparatus of claim 1, wherein the sample tray includes an aluminum or SST plate and the temperature-controlled tray holder provides temperature control to the plate.

10. The apparatus of claim 1 constructed and arranged for positioning in a Differential Scanning Calorimetry (DSC) system, a Thermogravimetric Analysis (TGA) system, and/or a Simultaneous Differential Thermal (SDT) Analysis system.

11. The apparatus of claim 1, wherein the gas flow control module provides purge control using a gas delivery module or mass flow controller.

12. The apparatus of claim 11, further comprising a vacuum for controlling the atmosphere.

13. The apparatus of claim 1, wherein the cover is a sealing cover that maintains the atmosphere, wherein a purge gas escapes from the apparatus while maintaining a positive pressure due to the sealing cover.

14. The apparatus of claim 1, wherein the gas flow control module includes a gas flow controller and a gas distribution and diffuser.

15. The apparatus of claim 1, wherein the gas flow control module provides purge gas pre-conditioning.

16. The apparatus of claim 1, wherein the gas flow and temperature control can react or prepare for disturbances in the heat and gas flow when the door or sample tray is open or the sample pan is introduced.

17. A thermal analysis instrument, comprising:
a sample tray;
an actuated tray cover constructed and arranged for positioning over a top surface of the sample tray to form a chamber providing a controlled environment between the tray cover and the sample tray;
a gas flow control module that distributes a purge gas to the chamber; and
a temperature-controlled tray holder coupled to a bottom surface of the sample tray to provide temperature control and thermal isolation to the chamber, including a temperature control system comprising a cooler and a heater for providing the temperature control to the chamber.

18. The thermal analysis instrument of claim 17, wherein the sample tray is an autosampler tray.

19. A sample tray, comprising:
a tray body having a plurality of compartments, each compartment constructed and arranged to hold a different sample;
a conductive plate coupled to a bottom surface of the tray body, the plate comprising a plurality of purge holes for distributing a source of purge gas uniformly to each of the plurality of compartments; and
a removal actuated tray cover constructed and arranged for positioning over a top surface of the sample tray for providing a controlled environment to the compartments between the tray cover and the tray body.

20. The sample tray of claim 19, further comprising:
a chill plate coupled to a bottom surface of the conductive plate; and
an insulative cover about the chill plate, the insulative cover including at least one input for receiving a source of dry purge gas.
